(19) United States
(12) Patent Application Publication
(10) Pub. No.: US 2015/0032898 A1
(43) Pub. Date: Jan. 29, 2015

(54) METHOD FOR ESTABLISHING A VIRTUAL COMMUNITY NETWORK CONNECTION AND A SYSTEM FOR IMPLEMENTING SAID METHOD

(71) Applicant: Gemtek Technology Co., Ltd., Hsinchu (TW)

(72) Inventor: DER-HWA TAN, Zhubei City (TW)

(73) Assignee: Gemtek Technology Co., Ltd., Hsinchu (TW)

(21) Appl. No.: 14/048,922

(22) Filed: Oct. 8, 2013

(30) Foreign Application Priority Data
Jul. 26, 2013 (TW) 102126920

(51) Int. Cl. H04L 29/06

(52) U.S. Cl. CPC H04L 65/1069
USPC 709/227

(57) ABSTRACT

The present invention discloses a method for establishing a virtual community network connection and a system for implementing said method. A method for establishing a virtual community network connection according to the present invention is for use with a router in a network communication system and includes the steps of:

sending registration information to a server in the network communication system, the registration information containing virtual community network data; sending a discovery request to the server, the discovery request containing community virtual switching data and an IPv6 Neighbor Solicitation; and receiving a discovery result returned from the server and establishing a connection to a remote router based on the discovery result.

### RELATED APPLICATIONS

This application claims priority to Taiwan Application Serial Number 102126920, filed Jul. 26, 2013, which is incorporated by reference herein in its entirety.

### BACKGROUND OF THE INVENTION

1. Field of the Invention

The present invention relates to a method for establishing a virtual community network connection and a system for implementing said method. More particularly, the present invention relates to a method for establishing a virtual community network connection, in which the connection is a peer-to-peer connection, and to a relevant network communication system.

2. Description of the Prior Art

With the rapid spread of the Internet, public IP (Internet Protocol) addresses under the IPv4 (Internet Protocol Version 4) standard have become insufficient to fulfill the needs of the fast-growing Internet users. As a result, ever since the idea of private network or enterprise intranet was brought up, private networks have been widely adopted in companies or organizations.

In the Request for Comments 1918 (RFC 1918) published by the Internet Engineering Task Force (IETF), private internets and the allocation of virtual IP addresses therefor are described and defined. Basically, a host allocated with a virtual IP address in a private network can access outside services via gateways or by using other methods, but it does not have network layer connectivity to access an external (public) IP address.

ZigBee protocol, a wireless networking protocol for low-data-rate and short-range transmissions, is currently being used by a certain number of electronic devices. However, communications using the ZigBee protocol have their limitations. Different electronic devices incorporating the ZigBee protocol cannot communicate with each other if they are not within a same pre-defined area; moreover, the communication is not possible because the devices with the ZigBee protocol may not have IPv4 connectivity. Therefore, given the existing tunneling protocols, to establish a connection between two ZigBee devices will require complicated procedures and configurations. In an age where user experience is highly valued, using complicated methods to set up network communications, however, is not user-friendly at all.

Apparently, existing network communication techniques still have room for improvement. As such, there exists a need in the market to provide users with a better method for establishing a virtual community network connection and a relevant network communication system, wherein the method and the system are more user-friendly and more convenient in terms of establishing network connections.

### SUMMARY OF THE INVENTION

In view of the prior art problems described above, an aspect of the present invention is to provide a method for establishing a virtual community network connection and a system for implementing said method that can solve the problems associated with the existing network communication techniques.

According to an aspect of the present invention, there is provided a method for establishing a virtual community network connection, wherein the method is for use with a router in a network communication system and includes the steps of: sending registration information to a server in the network communication system, the registration information containing virtual community network data; sending a discovery request to the server, the discovery request containing community virtual switching data and an IPv6 (Internet Protocol version 6) Neighbor Solicitation (NS) packet; and receiving a discovery result returned from the server and establishing a connection to a remote router based on the discovery result.

According to an aspect of the present invention, there is provided another method for establishing a virtual community network connection, wherein the method is for use with a router in a network communication system and includes the steps of: sending registration information to a server in the network communication system, the registration information containing virtual community network data; receiving a discovery request from the server, the discovery request containing community virtual switching data and an IPv6 Neighbor Solicitation; sending a discovery result to the server, the discovery result containing updated community virtual switching data and an IPv6 Neighbor Advertisement (NA) packet; and establishing a connection to a remote router.

According to an aspect of the present invention, there is further provided a network communication system including a server, wherein the network communication system implements the above methods for establishing a virtual community network connection.

The aforementioned aspects and other aspects of the present invention will be better understood with reference to the following exemplary embodiments and drawings.

### BRIEF DESCRIPTION OF THE DRAWINGS

FIG. 1 shows a schematic view of an environment for implementing a network communication system according to an embodiment of the present invention.

FIG. 2 is a schematic block diagram showing an embodiment of the network communication system as illustrated in FIG. 1.

FIG. 3 shows a sequence diagram of establishing a virtual community network connection according to an embodiment of the present invention.

FIG. 4 shows the data structure of a discovery request according to an embodiment of the present invention.

FIG. 5 shows a data structure of a discovery result according to an embodiment of the present invention.

### DETAILED DESCRIPTION OF THE PREFERRED EMBODIMENTS

The present invention will be fully described by way of preferred embodiments and appended drawings to facilitate the understanding of the technical features, contents and advantages of the present invention. It will be understood that the appended drawings are merely schematic representations and may not be illustrated according to actual scale and precise arrangement of the implemented invention. Therefore, the present invention shall not be construed based on the scale and arrangement illustrated on the appended drawings, and the embodiments and appended drawings are not intended to limit the scope of protection of the present invention.

### Exemplary Operating Environment

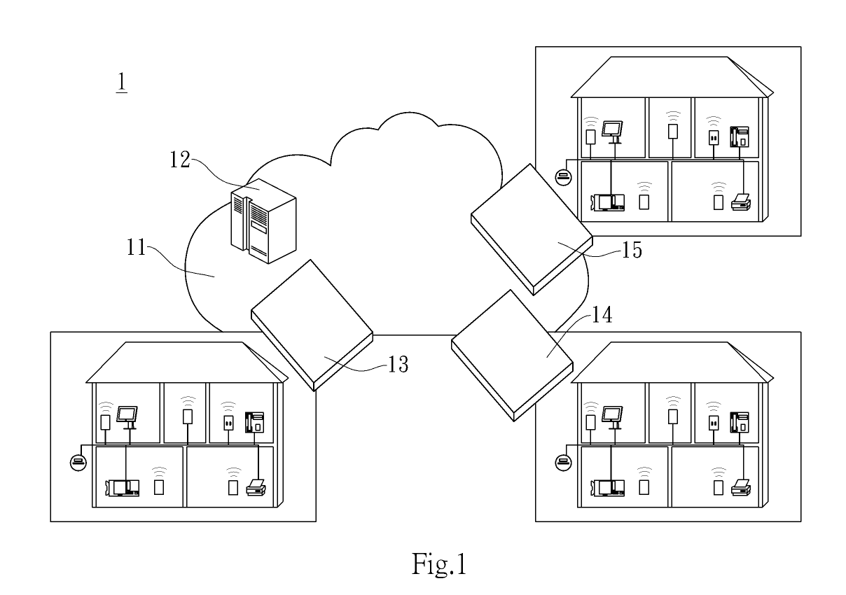

FIG. 1 shows components of a non-limiting example of an environment in which the described embodiments according to the present invention may be put into practice. Not all of the components may be required to practice the various embodiments, and variations in the arrangement and type of the components may be made without departing from the spirit or scope of the present invention. As shown in FIG. 1, a network communication system 1 may include the Internet, a plurality of servers, and a plurality of routers. The Internet 11 allows communications between a client and a server, and may include one or more local area networks (LANs) and/or wide area networks (WANs). For the purpose of explanation, a server 12 and three routers 13, 14, and 15 are included in this embodiment. However, the number of the servers and routers is exemplary and is not intended to limit the present invention; the number may vary in real practice.

In this embodiment, the three routers 13, 14, and 15 are preferably located in three different homes (as shown in FIG. 1). Further, there may also be a plurality of electronic devices in each of the three different homes shown here, and those electronic devices may incorporate the ZibBee protocol, a wireless networking protocol for low-data-rate and short-range transmissions (i.e., those electronic devices support 6LoWPAN, IPv6 over Low-Power Wireless Personal Area Networks).

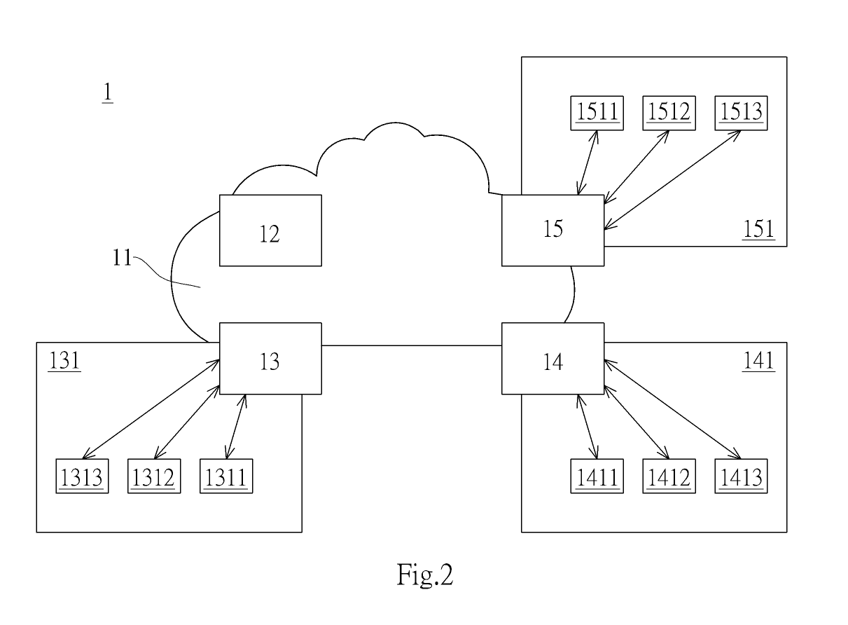

FIG. 2 is a schematic block diagram showing an embodiment of the network communication system as illustrated in FIG. 1; FIG. 2 further explains a basic implementation of the network communication system according to the present invention and its operating environment. As shown in FIG. 2, the network communication system includes Internet 11, a server 12, routers 13, 14, 15, homes 131, 141, 151, and several electronic devices, services or files 1311, 1312, 1313, 1411, 1412, 1413, 1511, 1512, 1513 located in respective homes. As described above, each home may include its own ZigBee wireless network protocol, so that the multiple electronic devices or files therein can communicate with each other within a certain area.

### Exemplary Operation

First, a member of home 131 may register with the server 12 via the router 13 to become a member of virtual community networks AA, BB and CC; similarly, a member of home 141 may register with the server 12 via the router 14 to become a member of virtual community networks AA and BB; and similarly, a member of home 151 may register with the server 12 via the router 15 to become a member of virtual community networks BB and DD. After a home member registers with the server as a member of a virtual community network via the router, the home member may then register the electronic devices, services or files that he or she owns. The registering process is for announcing that the registered electronic devices, services or files belong to that home member. Thus, the relationships among objects that are to be accessed can be defined, and sharing is possible among members of the same virtual community network.

To be more specific, members of respective homes may send registration information to the server 12 from respective routers 13, 14, and 15. The registration information includes an identification string and a media access control address (MAC address) of each router. After receiving the registration information sent from the respective routers, the server 12 stores the information, including the name, identification string and MAC address of each router, in a registration list.

The server 12 can process the data of multiple virtual community networks simultaneously, using identification strings to identify whether the routers belong to the same or different virtual community networks. If the registration information sent by multiple routers contains the same identification string, the server 12 can thus determine that the multiple routers with the same identification string belong to the same virtual community network.

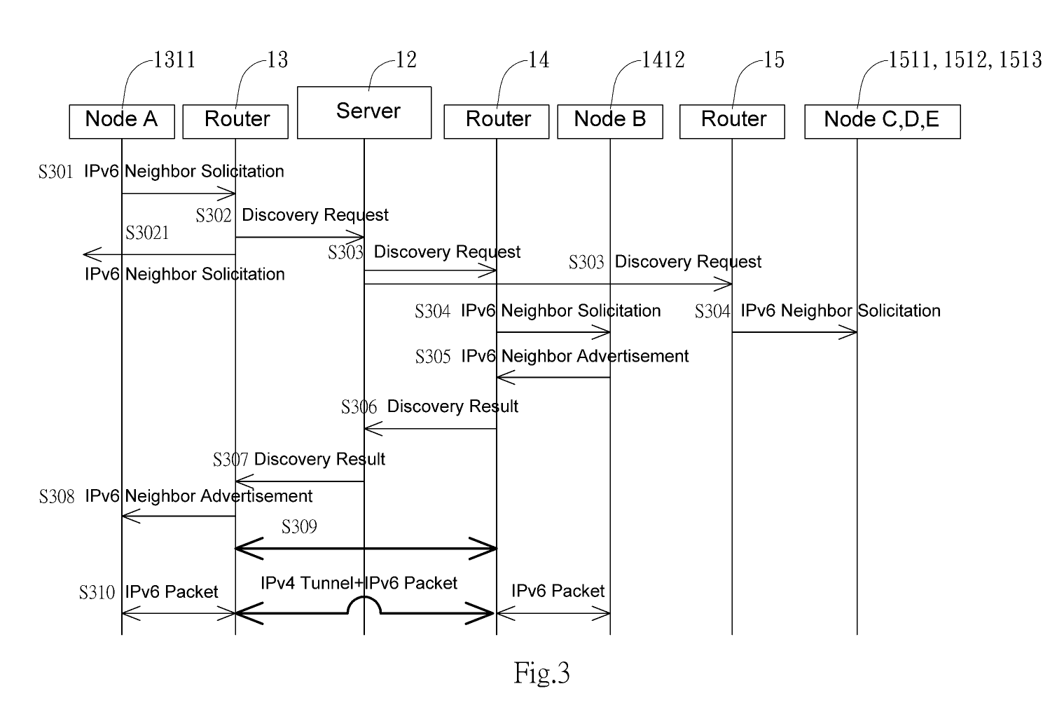

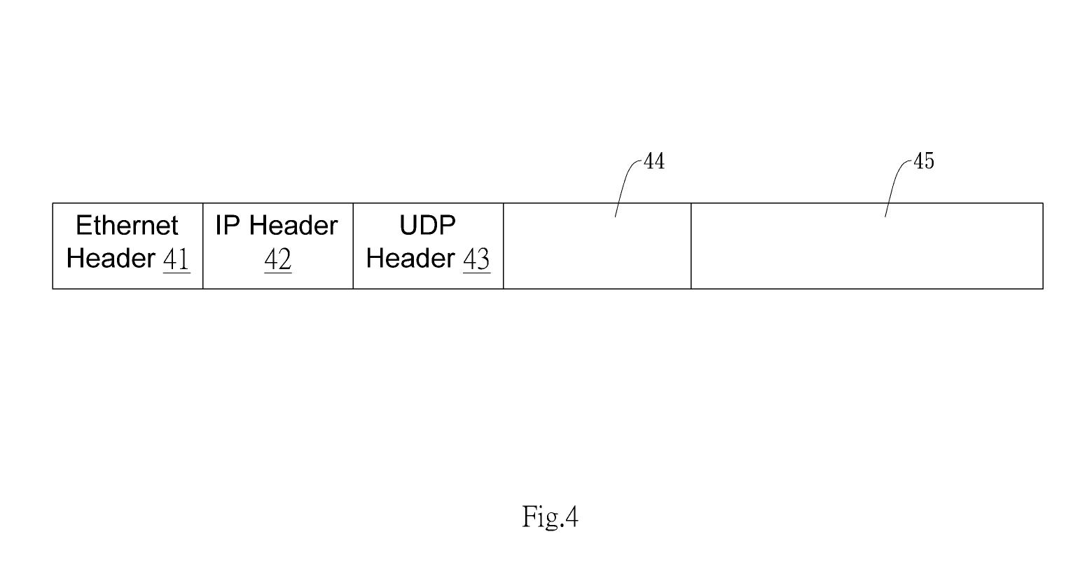

Please also refer to FIG. 3, which shows a sequence diagram of establishing a connection of a virtual community network according to an embodiment of the present invention. FIG. 3 illustrates the basic practice for establishing a connection of a virtual community network. As described above, after registering as a member of a virtual community network, a member of one home can search the server 12, via a router, for the electronic devices, services or files owned by a member of another home who belongs to the same virtual community network. For example, a member of home 131 can search the server 12, via the router 13, for the electronic device 1412 owned by a member of home 141, who also belongs to the virtual community network BB. To be more specific, a member of home 131 can send a discovery request in IPv4 format to the server 12 via the router 13 (see Step S302). This discovery request contains an Ethernet header 41, an IP header 42, and a UDP (User Datagram Protocol) header 43; in addition, this discovery request also contains a community virtual switch header 44 and an IPv6 Neighbor Solicitation 45 (see Step S301). FIG. 4 shows the data structure of this discovery request.

The IPv6 Neighbor Solicitation 45 may contain a destination device's multicast MAC address and a source device's link-local address. In this embodiment, for example, the destination device's MAC address may be the 64-bit ZigBee MAC address of the electronic device 1412 (i.e., node B in FIG. 3) located at home 141. And the source device's link-local address may be an IPv6 link-local address. In this embodiment, for example, this link-local address may include a prefix and the 64-bit ZigBee MAC address of the electronic device 1311 (i.e., node A in FIG. 3) located at home 131 (in practical implementations, for example, the IPv6 link-local address may be FE80::[the 64-bit ZigBee MAC address of the electronic device 1311]). On the other hand, the community virtual switch header 44 may contain the MAC address of the source router 13.

Furthermore, at the time that the router 13 sends the IPv4 discovery request to the server 12, it also sends IPv6 Neighbor Solicitations to other electronic devices (such as devices 1312 and 1313) located at home 131 (see Step S3021).

After receiving the discovery request in IPv4 format sent from the router 13, the server 12 will identify the MAC address of the router 13 contained in the community virtual switch header 44 and compare the MAC address with the data stored in the registration list. The server 12 then finds out that the router 13 has been registered as part of each virtual community network AA, BB and CC. Next, the server 12 sends the discovery request to all the routers in virtual community networks AA, BB and CC. In this embodiment, the server 12 sends the discovery request to routers 14 and 15 (see Step S303).

After receiving the discovery request, each of the routers 14 and 15 will respectively identify that the discovery request contains an IPv6 Neighbor Solicitation 45 and then send the IPv6 Neighbor Solicitation 45 further to the electronic devices, services or files at homes 141 and 151 that adopt the ZigBee wireless network protocol. In this embodiment, the router 14 sends the IPv6 Neighbor Solicitation 45 further to the electronic device 1412 (i.e., node B in FIG. 3) (see Step S304) and also to the other electronic devices, services or files 1411 and 1413. And the router 15 further sends the IPv6 Neighbor Solicitation 45 to the electronic devices, services or files 1511, 1512 and 1523 (i.e., nodes C, D and E in FIG. 3) at home 151. Since the destination device's MAC address contained in the IPv6 Neighbor Solicitation 45 refers to the 64-bit ZigBee MAC address of the electronic device 1412 (located at home 141), the electronic device 1412 will respond by sending an IPv6 Neighbor Advertisement back via the router 14 (see Step S305). In contrast, the other electronic devices, services or files 1411, 1413, 1511, 1512 and 1513 will not respond to the IPv6 Neighbor Solicitation 45.

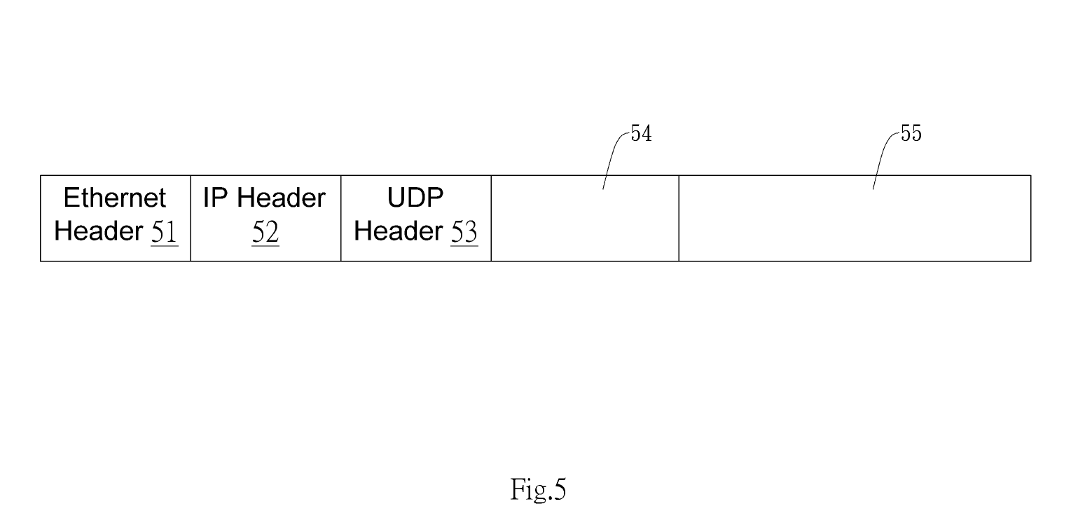

Next, after receiving the IPv6 Neighbor Advertisement sent back from the electronic device 1412, the router 14 then sends a discovery result in IPv4 format to the server 12 (see Step S306). This discovery result contains an Ethernet header 51, an IP header 52, and a UDP (User Datagram Protocol) header 53; in addition, this discovery result also contains an updated community virtual switch header 54 and an IPv6 Neighbor Advertisement 55. FIG. 5 shows the data structure of this discovery result.

Moreover, the IPv6 Neighbor Advertisement 55 may contain the 64-bit ZigBee MAC address of the electronic device 1412 and the 64-bit ZigBee MAC address of the electronic device 1311. The updated community virtual switch header 54 may contain the MAC address of the source router 14 and the MAC address of the destination router 13.

After receiving the discovery result in IPv4 format sent from the router 14, the server 12 will identify the MAC address of the destination router 13 contained in the community virtual switch header 54. The router 12 then sends the discovery result to the router 13 (see Step S307). After receiving the discovery result, the router 13 will identify that an IPv6 Neighbor Advertisement 55 is contained in the discovery result. The router 13 then sends the IPv6 Neighbor Advertisement 55 further to the electronic device 1311 located at home 131 (see Step S308).

Following the above steps, the router 13 can thus establish a virtual community network connection with the router 14 (see Step S309). To be more specific, the router 13 first sends a location request to the server 12; the server 12 then sends the location request to the router 14. Next, the router 14 sends location information back to the server 12; the server 12 then sends the location information to the router 13. Next, the router 13 sends a connection request to the router 14 based on the location information, trying to establish a connection directly; the router 14 then sends a response message to the router 13 based on the connection request. Lastly, a virtual community network connection between the router 13 and the router 14 is established. With this connection established, the router 13 and the router 14 can communicate with each other directly.

After the virtual community network connection between the router 13 and the router 14 is established, the electronic devices, services or files at home 131 can directly communicate with and connect to the electronic devices, services or files at home 141 without passing through a server (see Step S310). That is, the connection between the router 13 and the router 14 is a peer-to-peer connection. For example, after the virtual community network connection between the router 13 and the router 14 is established, a member of home 131 can store the files of digital photos taken with his/her digital camera (e.g., the electronic device 1311 in this embodiment) directly into a storage device (e.g., the electronic device 1412 in this embodiment) at home 141. Data can be transmitted through the direct communication and connection between the devices, without the need to passing through a server on the Internet.

A person having ordinary knowledge in the art will understand that the aforementioned quantities or ways of implementation associated with the server, virtual community network, home, electronic device, service or file, discovery request, discovery result, packet, etc., are exemplary and are not intended to limit the present invention. Any method for establishing a virtual community network connection or any network communication system that does not depart from the spirit and scope of the method or system of the present invention falls within the scope of the present invention.

To sum up, by using the method for establishing a virtual community network connection and the network communication system of the present invention, a user at one end can set up a virtual community network connection to a remote router of a destination object that belongs to the same virtual community network, even if the user does not know the global IPv6 address of that destination object. In consequence, direct sharing of electronic devices, services or files between users can be achieved. Therefore, establishing network connections and sharing electronic devices, services or files can be done in a more convenient and user-friendly manner.

The present invention, which includes a method for establishing a virtual community network connection and a network communication system, has been described above by way of preferred embodiments with reference to the accompanying drawings. All of the advantageous features disclosed in this specification may be combined in any combination. Each feature disclosed in this specification may be replaced by an alternative feature serving the same, equivalent, or similar purpose. Thus, except for those particularly distinctive features, each feature disclosed is only an example of a generic series of equivalent or similar features. Given the above description of preferred embodiments, those skilled in the art would understand that the present invention features several aspects of novelty and inventive step over the prior art and is industrially applicable. Various modifications and substitutions may be made by those skilled in the art without departing from the spirit and scope of the present invention.

What is claimed is:

1. A method for establishing a virtual community network connection, the method for use with a router in a network communication system, the method including the steps of:
sending registration information to a server in the network communication system, the registration information containing virtual community network data;
sending a discovery request to the server, the discovery request containing community virtual switching data and an IPv6 Neighbor Solicitation; and
receiving a discovery result returned from the server and establishing a connection to a remote router based on the discovery result.

2. The method according to claim 1, wherein the method further includes the following step prior to the step of sending the discovery request to the server:
receiving the IPv6 Neighbor Solicitation, the IPv6 Neighbor Solicitation containing a link-local address of a source object and a media access control address (MAC address) of a destination object; and
encapsulating the IPv6 Neighbor Solicitation and the community virtual switching data in an IPv4 packet to form the discovery request.

3. The method according to claim 2, wherein the MAC address of the destination object is in a format compliant with a wireless networking protocol for low-data-rate and short-range transmissions.

4. The method according to claim 2, wherein the link-local address is an IPv6 link-local address.

5. The method according to claim 1, wherein the community virtual switching data further contains a MAC address of the router.

6. The method according to claim 1, wherein the connection established between the router and the remote router is a peer-to-peer connection.

7. The method according to claim 1, wherein the step of establishing the connection to the remote router based on the discovery result further includes the following steps:
sending a location request to the server;
receiving location information returned from the server and sending a connection request to the remote router based on the location information;
receiving a response message from the remote router; and
establishing the connection to the remote router.

8. A method for establishing a virtual community network connection, the method for use with a router in a network communication system, the method including the steps of:
sending registration information to a server in the network communication system, the registration information containing virtual community network data;
receiving a discovery request from the server, the discovery request containing community virtual switching data and an IPv6 Neighbor Solicitation;
sending a discovery result to the server, the discovery result containing updated community virtual switching data and an IPv6 Neighbor Advertisement; and
establishing a connection to a remote router.

9. The method according to claim 8, wherein the method further includes the following steps prior to the step of sending the discovery result to the server:
sending the IPv6 Neighbor Solicitation further to one or more destination objects and receiving the IPv6 Neighbor Advertisement returned from one of the one or more destination objects; and
encapsulating the IPv6 Neighbor Advertisement and the updated community virtual switching data in an IPv4 packet to form the discovery result.

10. The method according to claim 8, wherein the IPv6 Neighbor Solicitation contains a link-local address of a source object and a MAC address of a destination object.

11. The method according to claim 10, wherein the MAC address of the destination object is in a format compliant with a wireless networking protocol for low-data-rate and short-range transmissions.

12. The method according to claim 10, wherein the link-local address is an IPv6 link-local address.

13. The method according to claim 8, wherein the community virtual switching data further contains a MAC address of the remote router, and the updated community virtual switching data further contains the MAC address of the remote router and a MAC address of the router.

14. The method according to claim 8, wherein the connection established between the router and the remote router is a peer-to-peer connection.

15. The method according to claim 8, wherein beyond the step of sending the discovery result to the server further includes the following steps:
receiving a location request from the server;
sending location information to the server;
receiving a connection request from the remote router and sending a response message to the remote router based on the connection request; and
establishing the connection to the remote router.

16. A network communication system including a server, wherein the network communication system implements a method for establishing a virtual community network connection as claimed in claim 1.
